(19) United States
(12) Patent Application Publication
(10) Pub. No.: US 2010/0176915 A1
(43) Pub. Date: Jul. 15, 2010

(54) Remote control communication system

(76) Inventor: Michael J. HAYES, Edwardsville, IL (US)

Correspondence Address: DOUGLAS E. WARREN;ATTORNEY AT LAW, P.O. BOX 6727, CHESTERFIELD, MO, 63006, US

(21) Appl. No.: 12/319,738

(22) Filed: Jan. 12, 2009

(51) Int. Cl. G08C 17/02; H04B 7/00

(52) U.S. Cl. 340/5.2; 455/41.2

(57) ABSTRACT

The present invention relates to remote control communication system that uses electromagnetic waves to communicate with and send commands to operate receiving devices. In a preferred embodiment of the present invention, the remote control communication system relates to a cellular telephone device that has been equipped with the necessary hardware and software to allow a user of the cellular telephone to communicate with certain devices that can be located within a building or similar structure such that the communications act to control activate, deactivate, monitor, or control the operation of the interior devices through an interface that can use the electromagnetic waves to operate the controlled devices.

### CROSS REFERENCE TO RELATED APPLICATIONS

Not applicable.

### STATEMENT REGARDING FEDERALLY SPONSORED RESEARCH

Not Applicable.

### BACKGROUND OF THE INVENTION

Modern wireless communication systems use a wide variety of technology to accomplish the communication between a transmitter and a receiver. The most common example is the ubiquitous cellular telephone that uses dedicated electromagnetic waves bands to provide mobile telephonic communication. With the widespread acceptance and use of cellular communication devices, there has been an explosion of various designs of optional communication devices that work in conjunction with the cellular phone. Once such device is the earpiece that cellular phone users can now use to operate a cellular telephone in a hands-free environment. Most of these optional earpieces use a wireless communication system by which the earpiece and the cellular telephone can communicate with each other during operation.

In most cases the wireless communication system uses for such communication utilizes an electronic polling method to facilitate channel sharing during use of the electronic devices. This special type of wireless communication is described in the publication entitled “Specification of the Bluetooth System,” (hereinafter “Bluetooth”) published by the Bluetooth SIG, v 1.0, Jul. 26, 1999. More specifically, the Bluetooth system is an exemplary technology for ad-hoc networking developed for short range wireless connectivity. Bluetooth is based on a short-range, universal radio link, and it provides a mechanism to form small ad-hoc groupings of connected devices, without a fixed network infrastructure, including such devices as printers, PDAs, desktop computers, FAX machines, keyboards, joysticks, telephones, or virtually any device capable of digital communication.

A new technology has been developed that can expand the use of mobile (portable) phones and related hand-held mobile terminals using the same industrial, scientific, and medical band as that employed by the wireless LAN (local area network) communication which conforms to the IEEE 802.11 standard. This new technology is known as the Bluetooth wireless technology which is a low-powered radio technology which allows users to make effortlessly, wireless and instant connections between various communication devices, such as mobile wireless phones and desktop and notebook computers. A communication linkup operating under the Bluetooth system, such as based on the standard dated Nov. 29, 1999, operates on the unlicensed 2.4 GHz ISM frequency band. In the vast majority of countries, including USA, Europe and most other countries, this frequency band actually is 2400-2483.5 MHz.

The sophisticated mode of transmission adopted in the Bluetooth specification ensures protection from interference and security of data. In most cases, a “frequency hop transceiver” is applied to combat interference and fading. A shaped, binary FM modulation is then applied to minimize transceiver complexity. The symbol rate is 1 Ms/s. For full duplex transmission, the time-division duplex (TDD) scheme is employed. With regard to channel linkup, information is exchanged through packets. Each packet is transmitted on a different “hop frequency.”

The Bluetooth specification has two power levels defined. More specifically, there is a lower power level that generally covers the small surroundings such as within a room, and there is also a higher power level that can cover a medium range, such as within a home. That is, conventionally, software controls and identity coding built into each microchip ensure that only those units preset by their owners can communicate.

Bluetooth is usually limited to short range communication, typically, fewer than 10 meters, for example, 2-3 meters, it requires a very little power level. However, the range may be extended to a 100 meters or more through simply increasing the transmit power level. Altogether, Bluetooth technology enables portable electronic devices to connect and communicate wirelessly by a short range, ad hoc networks. It is important to note, however, that even with the low power, Bluetooth doesn't require line of sight between communicating devices. The walls of a building does not generally inhibit the transmission or reception of a Bluetooth signal, making the standard useful for controlling several devices in different rooms or from a distance.

In most instances, Bluetooth can connect up to eight devices simultaneously. To prevent the potential communication interference between those devices, Bluetooth uses the spread-spectrum frequency hopping described above to reduce the likelihood that more than one device maybe transmitting on the same frequency at the same time.

### SUMMARY OF THE INVENTION

The various embodiments of the present invention include configurations of a remote control communication system having the ability to communicate with and generally control some of the operations of remote devices that are located at a distance from the remote control communicator. More specifically, the embodiments of the present invention can include a cellular telephone that has been modified to include the necessary hardware and software to remotely communicate with and control certain operations of the remote devices by use of a communication system generally incorporating Bluetooth communication technology.

### DESCRIPTION OF THE DRAWINGS

In the accompanying drawings which form part of the specification:

FIG. 1 is a schematic view showing the general communication and operation process of Bluetooth technology; and

FIG. 2 is a perspective view of one embodiment of the present invention.

Corresponding reference characters indicate corresponding parts throughout the several views of the drawings.

While embodiments of the present invention are illustrated in the above referenced drawings and in the following descriptions, it is understood that the embodiments shown are merely for purpose of illustration and that various changes in construction may be resorted to in the course of manufacture in order that the present invention may be utilized to fit the circumstances which may arise, without in any way departing from the spirit and intention of the present invention, which is to be limited only in accordance with the claims contained herein.

### DETAILED DESCRIPTION OF ONE PREFERRED EMBODIMENT

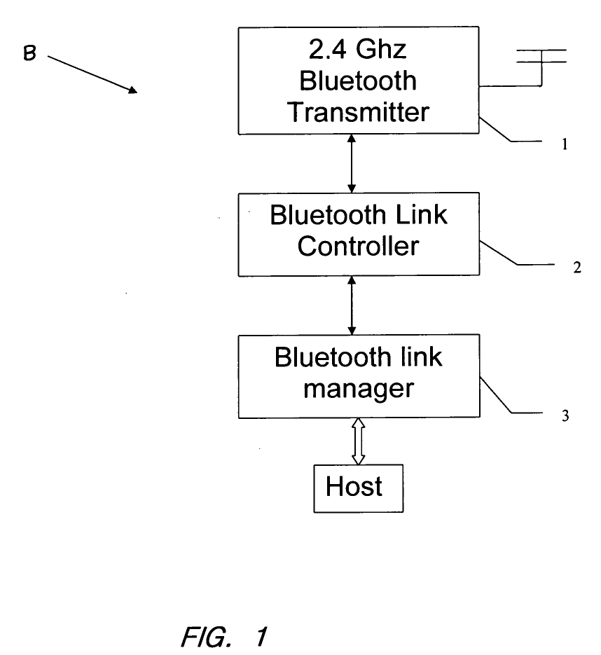

Wireless devices that conform to Bluetooth technology are generally as described in a typical Bluetooth System B as shown in FIG. 1. The Bluetooth System B comprises a Bluetooth transmitter unit 1, a Bluetooth link controller 2, and a Bluetooth link manager 3 that is a support unit for link management and host terminal interface functions. The Bluetooth link controller 2 in the Bluetooth System B (also referred to as the baseband section) describes the specifications of the digital signal processing portion of the hardware. This is to say, the Bluetooth link controller 2 carries out the baseband protocols and other low-level link routines. The Bluetooth link manager 3 is a software entity which carriers out link setup, authentication, link configuration, and other protocols. The Bluetooth link manager 3 discovers other remote link managers and communicates with them via the link manager protocol (LMP). Other details regarding the servicing by a link controller and link manager have been standardized by the Bluetooth SIG and can generally be found in the “Specification of the Bluetooth System,” published by the Bluetooth SIG, v 1.0, Jul. 26, 1999.

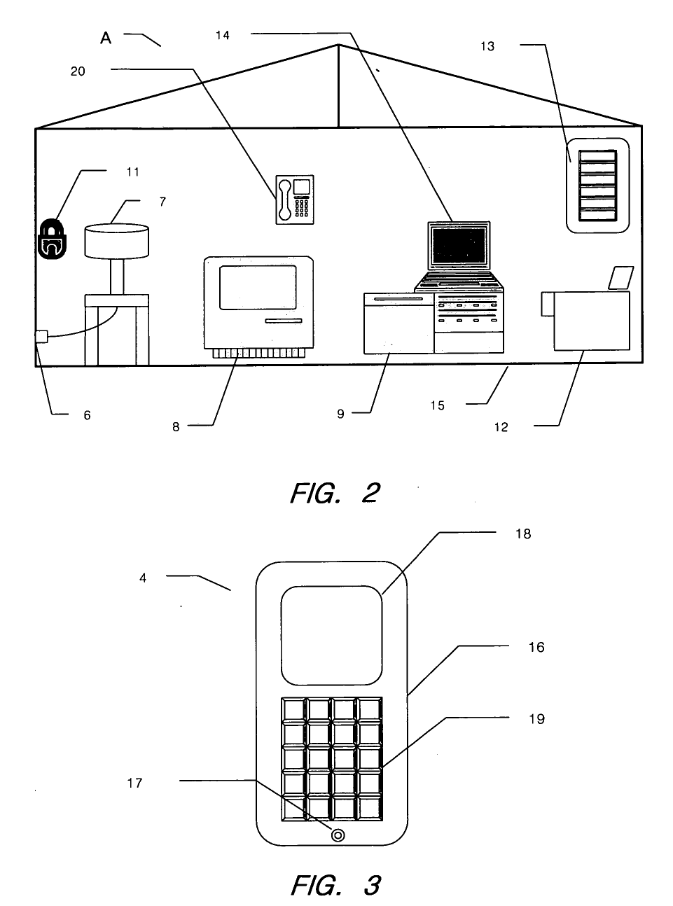

Referring now to FIG. 2, a preferred embodiment of the present invention is disclosed. More specifically, a remote control communication system A includes a remote control communication device 4, a controlled device 5, and a Bluetooth interface 6.

In one preferred embodiment, the remote control communication device 4 is a cellular telephone as shown in FIG. 3. The cellular telephone 4 includes hardware and software that allows the cellular telephone to communicate wirelessly with a plurality of controlled devices 5 using Bluetooth wireless technology. As shown in FIG. 1, the plurality of controlled devices 5 can include household objects and appliances such as lighting systems 6, televisions 7, audio systems 8, environmental control systems 9, security systems 10, cooking systems 11, main control panels 12, and any other device that can be adapted in a manner that allows the Bluetooth interface device to control at least one function of the controlled device 5. It will be appreciated by those of skill in the art that the plurality of controlled devices 5 can also include an intermediate Bluetooth interface apparatus 12 that can be inserted between a power source of the controlled device 5 and the controlled device itself. This is to say, the operation to be controlled for the controlled device 5 may simply be connecting and disconnecting the controlled device 5 from the power source of the controlled device by activating and deactivating the intermediate Bluetooth interface device 12. In this manner, a standard control device 5 such as a lamp 6 or cooking device 11 that is not inherently equipped to respond to Bluetooth communications or signals can nevertheless be indirectly controlled by a Bluetooth signal the may open or close a switch within the intermediate Bluetooth interface device 12 that connects the controlled device 5 to the power course for the controlled device. Thus, in an alternative embodiment of the present invention, the power connection for the controlled device 5 can be removed from a standard power outlet receptacle. Then, the intermediate Bluetooth interface 12 can be installed into a standard power outlet receptacle, after which the power connection of the controlled device 5 can be inserted into the intermediate Bluetooth interface device 12. Upon reception of a signal from the Bluetooth remote control communication device 4, the Bluetooth interface 5 can be activated or deactivated as desired to turn the controlled device on and off. It is understood that the Bluetooth interface device 5 may be either wired, as just described, or may itself be a wireless communication device that can relay a signal from the wireless Bluetooth interface to another Bluetooth interface, a controlled device 5, or any other apparatus that is equipped to receive a signal generated from the Bluetooth interface 6. Additionally, it is also understood that the Bluetooth interface 6 can be located in any manner, either inside or outside a building 13, as long as the Bluetooth interface can effectively receive the Bluetooth signal being transmitted by the remote control communication device 4.

In operation, the remote control communication device 4 (FIG. 3) in a preferred embodiment would be generally in the form of a cellular telephone 16 that can include voice activation and software recognition technology. The typical cellular telephone 16 generally comprises a microphone 17, a display 18, and a keypad 19. In the embodiment, the user can speak oral instructions into the microphone 17 of the cellular telephone 16 and the voice recognition technology can interpret the words communicated by the user into a specific signal that can be wirelessly communicated from the cellular telephone to the either the Bluetooth equipped controlled device 5 or the Bluetooth interface device 6. As alternative embodiment, the user can enter commands to the Bluetooth system by entering words and numbers into the cellular 16 telephone through the keypad 19.

In some preferred embodiments of the present invention, the remote control communication device 4 can also include the use of an authentication code by which the remote control communication device 4 can ascertain that an authorized party is using the remote control communication device. In the case of words spoken into the remote control communication device 4, the voice technology of the remote control communication system A would not be permitted to function in conjunction with the controlled devices 5 until the user of the remote communication device first speaks the proper authentication word that can be either a word or a passphrase. In other embodiments, the authentication code can be a word or series of words that are entered into the remote control communication system A by entering those words or passwords into the cellular telephone 16 through the keypad 19. Use of the authentication code would prevent the unauthorized use of the remote communication device 4 if it is lost or stolen.

In yet another alternative embodiment, the remote communication device 4 can be generally integrated into a vehicle such as an automobile or truck. In that embodiment, the general operation of the remote communication system A is generally similar to the embodiments described above using a cellular telephone, with the exception that the remote communications device 4 can be either an add-on device or an integrated device that is substantially installed into a vehicle rather than being a fully mobile device such as a cellular telephone. In this alternative embodiment, the hardware and software necessary to communicate with the Bluetooth interface device 6 can be either installed integrally into the vehicle or can be included in a device that be installed into or onto the vehicle. In operation of that embodiment, a user that is within the range of the Bluetooth interface devices 6 will be capable of activating the Bluetooth interface devices by either speaking commands into the remote communication device 4, when voice recognition technology is used, or can enter an authorization code into a data entry device of the remote communication device 4 to initiate the process that allows the remote communication device to communicate with the Bluetooth interface devices 6. The remainder of the operation of the remote communication system A is similar to the operation of that system as described above.

In other embodiments of the present invention, the remote communication system A can include a second remote communication device 20 (FIG. 2) that resides in a location other than a cellular phone or a vehicle. For example, a second remote communication system A can be installed within a building such that the second remote communication system can generally communicate with the first remote communication system. In that embodiment, the second remote communication device 20 can be located somewhere within the range of the Bluetooth interface devices 6 that will allow a user to communicate with the interface devices from a second location. For example, a user in an automobile would enter an area where the remote communication device 4 can communicate with at least one of the Bluetooth interface devices 6. When the remote communication device 4 is a cellular telephone, the user would speak or enter an authentication code into the cellular telephone or into a device that has been installed onto a vehicle. Voice recognition technology within the remote communication system would again either identify the owner by voice pattern comparison or by comparing the authentication code entered onto a key pad with the authentication code stored within the remote communication system A. If the user is properly identified by the remote communication system as an authorized user of the system, that acceptance is made known to the user who can then speak or enter the next command into the cellular telephone to initiate communication to the Bluetooth interface device 6 while using Bluetooth wireless communication technology. For example, the user can speak or enter a command that can open the garage door by activation of the garage door opening system. Once the user has left the user's automobile, the user can enter the home. Because the second remote communication device 20 is disposed near the second remote communication system, and because the second remote communication system is in general communication with the first remote communication system A, the user can speak a new command within the home that will be detected and processed by the second remote communication device 20. It is understood that because the first remote communication system A is in general communication with the second remote communication system 20, authorization of the user in the first remote communication system results in the authorization of the user with regard to the second remote communication system without repeating the user authorization sequence. Thus, in the present example, after using the first remote communication system A to open a garage door of a building, for example, after entrance into the home, the user could send a new command to the second remote communication system 20 for closing the garage door and the secondary remote communication device would abbey that order.

While the above description describes various embodiments of the present invention, it will be clear that the present invention may be otherwise easily adapted to fit any configuration where a remote control communication system is required. Additionally, as various changes could be made in the above constructions without departing from the scope of the invention, it is also intended that all matter contained in the above description or shown in the accompanying drawings shall be interpreted as illustrative and not in a limiting sense. The scope of the invention should be determined by the appended claims and their legal equivalents, rather than by the examples given.

1. A remote control communication system comprising:
a remote communication device capable of transmitting a Bluetooth wireless signal;
a device to be controlled; and
a Bluetooth interface device capable of receiving the Bluetooth wireless signal and capable of interfacing with the device to be controlled such that at least one of a set of functions of the device to be controlled can be effected by the Bluetooth interface device.

2. The remote control communication system of claim 1 wherein the remote communication device can be used to communicate with the remote control communication system only after an authentication code has been communicated to, and accepted by, one of either the remote communication device or the remote control communication system.

3. The remote control communication system of claim 2 wherein the authentication code is at least one of either a letter, a word, a number, a punctuation mark, or a symbol.

4. The remote control communication system of claim 3 wherein the authentication code is communicated to the remote communication device by a user that enters the authentication code into a keyboard that is communicatively connected to the remote communication device.

5. The remote control communication system of claim 4 wherein one of either the remote communication device or the remote control communication system comprises a voice recognition technology.

6. The remote communication system of claim 5 wherein either the remote communication device or the remote communication system is capable of receiving a set of audio signals from a microphone.

7. The remote control communication system of claim 6 wherein the set of audio signals includes the authentication code that is communicated to at least one of either the remote communication device or the remote communication system by the user who speaks the authentication code into the microphone.

8. The remote communication system of claim 7 wherein the set of audio signals that includes the authentication code is received by the voice recognition technology that translates the audio signal into an authorization code input that is communicated to an authorization process that determines if the authorization code within the set of audio signals matches a preset authorization code that allows the user to communicate further with the remote communication system.

9. The remote control communication system of claim 8 comprising an operational process that allows the user to input at least one operation command into the remote communication device wherein the operation command is resolved into at least one operation command signal that is communicated to the Bluetooth interface device.

10. The remote control communication system of claim 9 wherein the at least one operation command signal is communicated wirelessly to the Bluetooth interface device.

11. The remote control communication system of claim 10 wherein the Bluetooth interface device is capable of communicating with the device to be controlled in a manner that controls at least one function of the device to be controlled.

12. The remote control communication system of claim 11 wherein the remote communication system comprises a first remote communication system and a second remote communication system, wherein the second remote communication system includes one of either all of a set of components that constitute the first remote communication system, a part of the set of components that constitute the first remote communication system, or a set of additional components that do not constitute the set of components that constitute the first remote communication system, and wherein the remote communication system is capable of communicating with the second remote communication system such that the when the first remote communication system has ascertained that the authorization code submitted by the user matches the preset authorization code of the first remote communication system, the user is permitted to communicate further with the second remote communication system.

13. A remote control communication system comprising:
a remote communication device capable of transmitting a Bluetooth wireless signal;
a device to be controlled; and
a Bluetooth interface device capable of receiving the Bluetooth wireless signal and wherein the Bluetooth interface device is capable of interfacing with the device to be controlled such that at least one of a set of functions of the device to be controlled can be effected by the Bluetooth interface device only after an authentication code has been communicated to, and accepted by, one of either the remote communication device or the remote control communication system.

14. The remote control communication system of claim 13 wherein the authentication code is at least one of either a letter, a word, a number, a punctuation mark, or a symbol.

15. The remote control communication system of claim 14 wherein the authentication code is communicated to the remote communication device by a user that enters the authentication code into a keyboard that is communicatively connected to the remote communication device.

16. The remote control communication system of claim 15 wherein one of either the remote communication device or the remote control communication system comprises a voice recognition technology and wherein either the remote communication device or the remote communication system is capable of receiving a set audio signals from a microphone.

17. The remote control communication system of claim 16 wherein the set of audio signals includes the authentication code that is communicated to at least one of either the remote communication device or the remote communication system by the user who speaks the authentication code into the microphone and wherein the voice recognition technology that translates the audio signal into an authorization code input that is communicated to an authorization process that determines if the authorization code within the set of audio signals matches a preset authorization code that allows the user to communicate further with the remote communication system.

18. The remote control communication system of claim 17 comprising an operational process that allows the user to input at least one operation command into the remote communication device wherein the operation command is resolved into at least one operation command signal that is communicated wirelessly to the Bluetooth interface device, and wherein the Bluetooth interface device is capable of communicating with the device to be controlled in a manner that controls at least one function of the device to be controlled.

19. The remote control communication system of claim 18 wherein the remote communication system comprises a first remote communication system and a second remote communication system, wherein the second remote communication system includes one of either all of a set of components that constitute the first remote communication system, a part of the set of components that constitute the first remote communication system, or a set of additional components that do not constitute the set of components that constitute the first remote communication system, and wherein the remote communication system is capable of communicating with the second remote communication system such that the when the first remote communication system has ascertained that the authorization code submitted by the user matches the preset authorization code of the first remote communication system, the user is permitted to communicate further with the second remote communication system.

20. A remote control communication system comprising:
a remote communication device capable of receiving a communication that includes an authentication code that can be communicated by a user to one of either the remote communication device or the remote control communication system; wherein the authentication code is at least one of either a letter, a word, a number, a punctuation mark, or a symbol; wherein either the remote communication device or the remote control communication system comprises a voice recognition technology; wherein either the remote communication device or the remote communication system is capable of receiving a set audio signals from a microphone;
a device to be controlled; and
a Bluetooth interface device capable of receiving the Bluetooth wireless signal wherein the Bluetooth interface device is capable of interfacing with the device to be controlled such that at least one of a set of functions of the device to be controlled can be effected by the Bluetooth interface device only after the authentication code has been communicated to, and accepted by, one of either the remote communication device or the remote control communication system.

21. The remote control communication system of claim 20 wherein the authentication code is communicated to one of either the remote communication device or the remote communication system by the user that one of either enters the authentication code into a keyboard that is communicatively connected to the remote communication device or speaks the authentication code into the microphone to generate a set of audio signals that is communicated to the voice recognition technology for translation of the audio signal into an authorization code input that is communicated to an authorization process that determines if the authorization code within the set of audio signals matches a preset authorization code that allows the user to communicate further with the remote communication system.

22. The remote control communication system of claim 21 wherein the remote communication device is a cellular telephone that includes the microphone wherein after the authentication code has been determined to match the preset authentication code, the user speaks an operation command into the microphone that results in a control an operation of the device to be controlled, and wherein the remote communication system uses the Bluetooth interface device to control the operation of the device to be controlled.
